(19) United States
(12) Patent Application Publication
(10) Pub. No.: US 2022/0044241 A1
(43) Pub. Date: Feb. 10, 2022

(54) Achieving Decentralized Blockchain Consensus Using A State Function Driven Protocol

(71) Applicant: Dan Lu, Harrisburg, NC (US)

(72) Inventor: Dan Lu, Harrisburg, NC (US)

(21) Appl. No.: 17/140,095

(22) Filed: Jan. 3, 2021

Related U.S. Application Data
(60) Provisional application No. 63/063,277, filed on Aug. 8, 2020.

(51) Int. Cl. G06Q 20/40; G06F 16/23; G06F 16/27; H04L 9/30; G06Q 20/38; G06Q 20/36; H04L 9/32

(52) U.S. Cl. CPC G06Q 20/401; G06F 16/2379; G06F 16/27; H04L 9/3073; G06Q 2220/00; G06Q 20/36; H04L 9/3239; H04L 2209/56; G06Q 20/3829

(57) ABSTRACT

A new consensus protocol is proposed and implemented for a cryptocurrency blockchain in an open decentralized peer-to-peer network. At any point of time during the blockchain's ongoing transactional activities, an administrator is selected by computing a state function of the blockchain, the administrator builds a new block and appends it to the blockchain and synchronizes it through the peer-to-peer blockchain network. By computing the state function the administrator can identify any failed administrators prior to its selection and removes the failed ones from the system. The new state function driven protocol provides a democratic and equal way for each of the peer-to-peer network nodes to participate in building the blocks and sharing the rewards. The state function driven protocol is auditable and verifiable at any time by any participating network node.

### PRIORITY

The present application claims priority to the earlier filed provisional application with application No. 63/063,277, file date of 2020 Aug. 8, and hereby incorporates subject matter of the provisional application in its entirety.

### BACKGROUND OF THE INVENTION

Blockchain is the underlying technology for cryptocurrencies. A blockchain is a decentralized distributed ledger which records transactions and groups transactions into a chain of logical units called blocks. The ongoing transaction recording activities are maintained by a peer-to-peer network of participating computer nodes. A blockchain consensus protocol is a process for participating network nodes to select an administrator to record transactions in blocks and to synchronize blocks across all copies of blockchains.

Currently cryptocurrencies use either proof-of-work (PoW), or proof-of-stake (PoS), or any of the variations of two as the consensus protocol. The proof-of-work protocol requires participating network nodes to compete by solving a highly computational power consuming hash puzzle called mining, and the winner of each round of the competitions is the selected administrator to build the transaction block and broadcast the block to the network to synchronize all the blockchain copies, new cryptocurrency values, i.e., cryptocurrency coins, are created from building each block and rewarded to the administrator. The proof-of-stake protocol follows a similar competition process for selecting an administrator, but lowers the bar of the difficulty of the hash puzzle for those which invest higher stakes in the system. For the safety of the network, the blockchain network requires no single network node can exceed 51% of hash computing power.

While the proof-of-work and the proof-of-stake consensus protocols achieve tremendous success in cryptocurrencies, the required high computational power consuming mining or high stakes invested raise concerns by many: 1) a waste of electricity energy regarded as unnecessary; 2) leading to a trend towards centralization and monopoly of power that practically excludes most of network nodes from participating in the block building process with rewards, which is the opposite of the original design idea of decentralization of blockchain, and poses security risk of breaching the 51% hashing power rule. The blockchain business user community has been expressing the need for a new protocol to work in a more equal way for each of the participating network nodes.

### SUMMARY OF THE INVENTION

This invention uses a state function driven protocol to achieve consensus for a distributed and decentralized blockchain system. The new consensus protocol results a truly decentralized and democratic way in which each of participating network nodes has equal rights and opportunities in contributing to the building of the blocks to the blockchain. The consensus protocol does not require super heavy computing power from the participating network nodes in order to achieve consensus. The consensus process is auditable and verifiable at any point of time by any of the participating network nodes.

A blockchain state is determined by its content, a collection of transactions, a chain of logical groupings of the transactions (blocks), and a collection of the network nodes upon which the blockchain is maintained. A blockchain state function is a unique and surjective mapping between a set of values and a set of blockchain states.

A state function driven consensus protocol is to define a state function that maps each of the blockchain states in the whole state space to each of the participating network nodes id at any given point of time. The state function is pre-built in the blockchain system with global adjustable parameters. The protocol is executed on the local copy of the blockchain at each network node upon a change in the blockchain state. When the output of the executed protocol matches the network node id where the local copy of the blockchain is maintained, the network node will build the next block and broadcast the block to other network nodes to achieve consensus. In the case of the selected network node is off line or fault, the protocol automatically ensures selection of the next network node upon progression of state.

### BRIEF DESCRIPTION OF THE DRAWINGS

FIG. 1 Blockchain data model

FIG. 2 Blockchain state function driven consensus protocol

FIG. 3 Process flow for creating a block

FIG. 4 Process flow for receiving and synchronizing a block

FIG. 5 Process flow for a member to join/rejoin the network

### DETAILED DESCRIPTION OF THE INVENTION

The present disclosure is described using a cryptocurrency blockchain system built on an account-based transaction ledger, maintained by an open, decentralized peer-to-peer network of computer nodes.

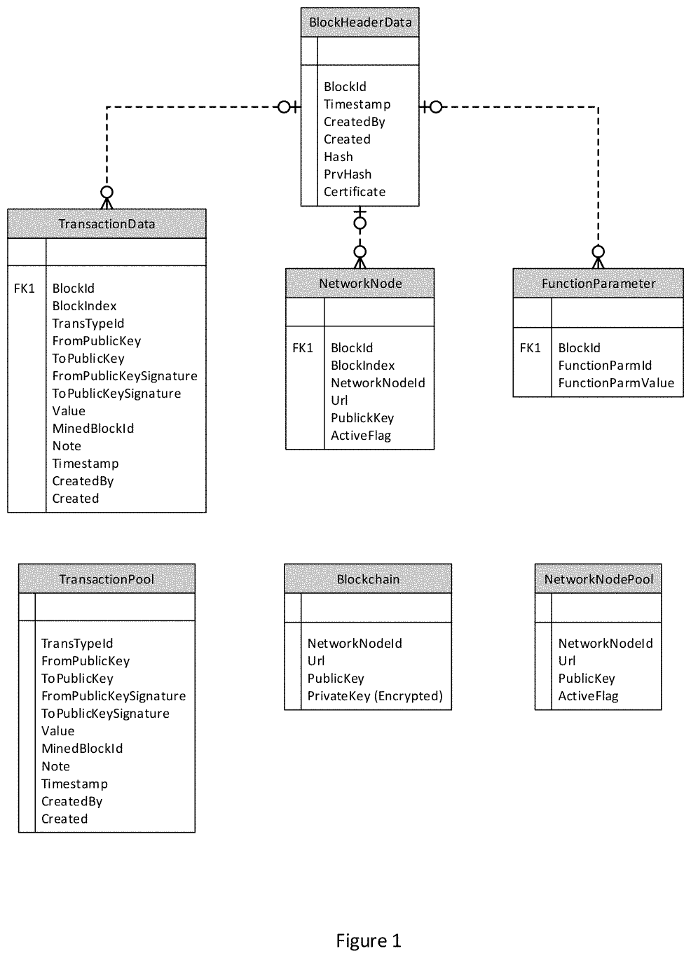

FIG. 1 shows the data model of the blockchain system. The data model consists of the following entities:
1. BlockHeaderData
   BlockHeaderData entity contains header information of each block in the blockchain.
2. TransactionData
   TransactionData entity contains all transaction entries that have been built into the blockchain, with a block id as the foreign key to group transaction entries into blocks. Within each block, transaction entries are ordered by the block index.
3. NetworkNode
   NetworkNode entity contains records of network nodes registered in the blockchain, with a block id as the foreign key to mark at which block when the network node is registered to the system, or at which block when the network node is removed from the system.
4. FunctionParameter
   FunctionParameter entity contains data used for blockchain and blockchain state function, with a block id as the foreign key to indicates which block the function parameters are applied for.
5. TransactionPool
   TransactionPool entity contains all transaction entries that have been received by the system but not yet being built into the blockchain.
6. NetworkNodePool
   NetworkNodePool entity contains all the newly joined network nodes that have not yet being registered in the blockchain.
7. Blockchain
   Blockchain entity contains a single record for the local network node. Each network node has an associated cryptocurrency wallet with a private and public key pair. When a network node is selected as administrator to build a block, the associated wallet's private key is used to sign the block hash as the block building certificate. After a network node is selected as an administrator and successfully builds a block, administration fee will be sent the wallet public key, by the next administrator selected to build the next block.

Active Registered Network Nodes (ARNN) are defined as the set of all active network nodes built into the blockchain, ordered by block id and block index.

AN={n₀,n₁,n₂, . . . ,n_{N-1}} (1)

where N is the total number of ARNN.

The collection of indices of the active registered network nodes is a set of whole numbers that identifies any specific node in AN

IN={0,1,2, . . . ,N−1} (2)

Live Network Nodes (LNN) are defined as a union of ARNN and newly joined network nodes in NetworkNodePool entity.

A transaction batch number b of a transaction pool is defined as a step function that maps the transaction pool size S to a whole number

b=Σₙ₌₀^{∞}n X_{An}(S),b∈IN,S∈IN (3)

where Aₙ is an interval of the whole number

Aₙ={Tₙ+1, . . . ,TₙSₙ},Tₙ=Σᵢ₌₀ⁿ⁻¹Sᵢ (4)

Sₙ is the size of the interval Aₙ, and X_{A}(S) is the indicator function

$${X}_{A} ( S ) = \{ \begin{matrix}1 , & S ∈ A \\ 0 , & otherwise\end{matrix} \qquad ( 5 )$$

The such defined transaction batch number provides a scaled-up measure of the transaction pool size. Note that if all the interval sizes are chosen to be the same, i.e., Sᵢ=S₀, the transaction batch number is the quotient of the division of transaction pool size by the interval size

$$b = \frac{S}{{S}_{o}} \qquad ( 6 )$$

A blockchain state function is defined as a unique and surjective mapping between the blockchain state and active registered network nodes

f=f(B_{N},b)b>0,f∈IN (7)

where B_{N} is the blockchain state with N blocks and b is the transaction batch number of the transaction pool.

The specific state function form for the cryptocurrency in this disclosure is chosen as

f=f(Bₙ,b)=SA(H(Hₙ|b))mod L,b>0,f∈IN (8)

where Hₙ is the hash of the last block in the blockchain, H( ) is the SHA-256 hash function, the vertical bar | denotes string concatenation, b is the transaction batch number from equation (6), L is the size of the active registered network nodes. An Ascii summation function SA is defined as

SA=Σᵢ₌₀^{K-1}ASCII(Sᵢ) (9)

where K is the length of the string and Sᵢ is the character at position i of the string, ASCII(s) is the ascii code of character s.

An administrator is defined as the selected network node from ARNN by computing equation (7), (8) to build a new block and synchronize the block across the peer-to-peer network.

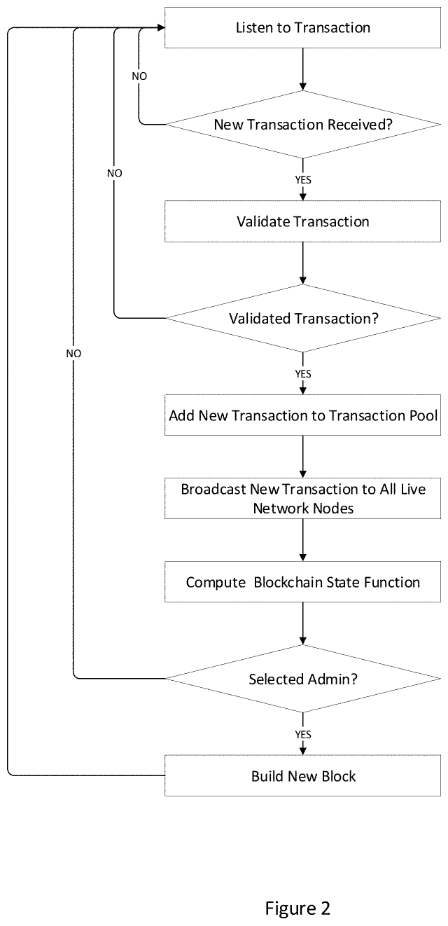

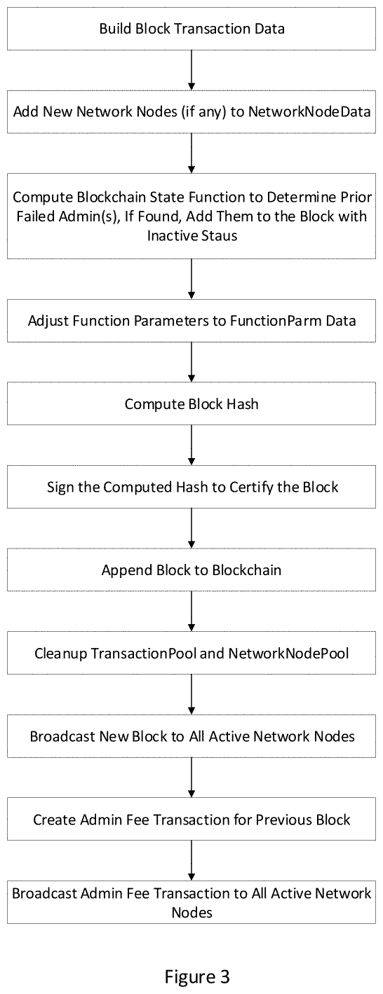

FIG. 2 shows the process flow of the state function driven consensus protocol that each of ARNNs follows to receive and process transaction entries, and to select an administrator to build blocks for the blockchain and to synchronize blocks across the decentralized peer-to-peer network.
1. Each ARNN has a service end point to listen and receive transaction entries, the transaction entries can be either posted directly from network users, or broadcasted from other ARNNs.
2. After a transaction entry is received, it is validated against transactions in the blockchain and in the transaction pool. If the transaction is valid, it is added to the TransactionPool entity.
3. If a new transaction is added to the TransactionPool, it is broadcasted to all LNN.
4. The state function in equation (8) is computed to find the selected administrator for building the next block.
5. If the result from the calculated state function indicates the selected administrator is the local network node itself, it performs that task to build a next block (detailed steps for building a block described in FIG. 3).

A Failed Administrator (FA) is defined as an administrator selected by the blockchain state function but does not perform its duty, this can be caused by the network node being offline, at fault, or any other process or network failures. If the transaction batch number b used in the FIG. 2 step 4 to compute the state function to select administrator is greater than 1 (b>1), it indicates that there exist FA(s) prior to the selected administrator for the block. The FA(s) can be identified by computing the state function in equation (8) for all transaction batch number(s) from 1 to b−1

fᵢ=f(Bₙ,bᵢ)=SA(H(Hₙ|bᵢ))mod L,i,bᵢ∈{1, . . . ,b−1},fᵢ∈IN (10)

FIG. 3 show the detailed steps to build a block.
1. Move S number of transaction entries from TransactionPool entity to TransactionData entity. The number S is the transaction pool size when the state function is calculated to select the administrator (step 4 from FIG. 2). The transaction entries are marked with a new block id equal to the block id of the last block in the blockchain plus 1, the transaction entries are ordered by the local timestamp when they are received, and each of the transaction entries is assigned a block index ranging from number 1 to S according to their orderings.
2. If there are newly joined network nodes in NetworkNodePool entity, move all the entries from the NetworkNodePool entity to NetworkNode entity, each new network node is marked with the new block id from step 1, and the new network nodes are ordered by the local timestamp when they are joined, and each of the new network nodes is assigned a block index ranging from number 1 to L where L is the NetworkNodePool size according to their orderings.
3. If the selected administrator from the state function (8) is calculated with a transaction batch number b>1, use equation (10) to get all FA(s) and create an entry for each of the FA(s) in the NetworkNode entity with the block id from step 1, block index equal to the index i from equation (10), and ActiveFlag equal to N as inactive.
4. Take all the entries from FunctionParameter entity with previous block id, adjust the parameters if necessary, create entries with block id from step 1.
5. Compute block hash and add the hash to the block header record with the previous block hash.
6. Use the associate wallet's private key to sign the block hash and add the signature to the block header record as the block certification.
7. Append the block the local copy of the blockchain.
8. Cleanup TransactionPool and NetworkNodePool to remove records that has been built into the block.
9. Broadcast the new block to all LNN.
10. Create a transaction entry to pay administration fee to the network node that built the previous block. The administration fee is paid to the public key of the wallet associate with the network node.
11. Broadcast the administration fee transaction entry to all LNN.

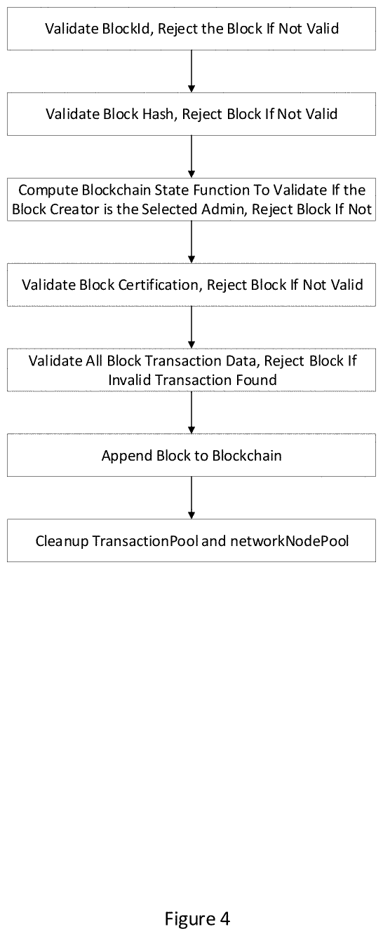

Each LNN has a service end point to receive a new block built and broadcasted by a selected administrator. FIG. 4 show the detailed steps a LNN to process a received new block.
1. Validate block id, the block id must be equal to the block id plus 1 from the last block of the local copy of the blockchain. If the block id is invalid, reject the block.
2. Valid the previous hash value of the block is equal to the hash value of the last block of the local copy of the blockchain. If it is invalid, reject the block.
3. Compute the block hash using the block data, validate the computed hash is equal to the hash value of the block. If it is invalid, reject the block.
4. Compute the blockchain state function in equation (8) to validate the block creator is the selected administrator determined by the blockchain state function. If it is invalid, reject the block.
5. Use the block creator's public key to validate the block's certificate, if it is invalid, reject the block.
6. Validate all the transaction entries in the block, if any of the entries are found invalid, reject the block.
7. If all the validations from the above steps are passed, append the received block to the local copy of the blockchain.
8. Cleanup TransactionPool and NetworkNodePool to remove the records that have been built into the block.

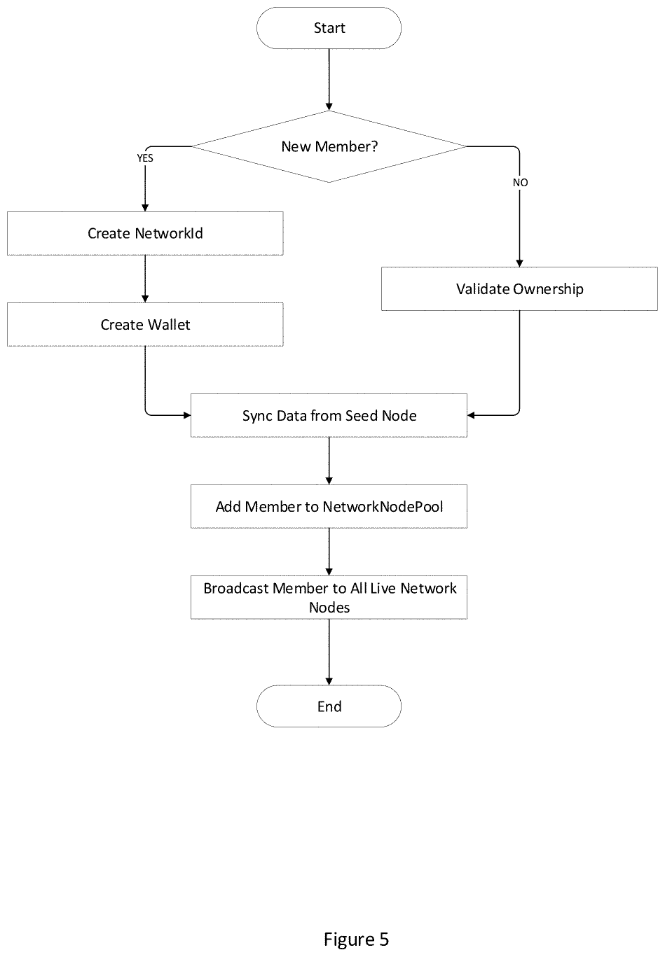

FIG. 5 shows the steps for a network node to join or rejoin the peer-to-peer blockchain network. A node can join and leave the network at any time. An offline node or a removed FA can rejoin the network at any time.
1. If the node is a new member to join the network at first time, create a network id, create a wallet with public and private key pair for the node.
2. If the node is an existing member being offline or FA to rejoin the network, enter the member wallet private key to validate the existing membership.
3. Load and synchronize blockchain data from an ARNN (seed).
4. Create an entry in NetworkNodePool for node.
5. Broadcast the joined/rejoined node to all LNN.

What is claimed is:

1. A system with a data model comprising the followings:
a. BlockHeaderData which contains header information of each block in the blockchain;
b. TransactionData which contains all transaction entries on the accounting ledger, with a block id as the foreign key to group transaction entries into blocks; within each block, transaction entries are ordered by the block index;
c. NetworkNode which contains records of network nodes joined to the decentralized peer-to-peer network and registered in the blockchain, with a block id as the foreign key to mark at which block when the network node is registered to the system, and at which block when the network node is removed from the system if the network node is a failed administrator;
d. FunctionParameter which contains data used for blockchain and blockchain state function, with a block id as the foreign key to indicates which block the function parameters are applied for;
e. TransactionPool which contains all transaction entries that have been received by the system but not yet being built into the blockchain;
f. NetworkNodePool which contains all the newly joined network nodes that have not yet being registered in the blockchain;
g. Blockchain which contains a single record for the local network node and its associated wallet public and private key pair.

2. A method to compute a transaction batch number b of a transaction pool using a formula defined as a step function that maps the transaction pool size to a whole number, providing a scaled-up measure of a transaction pool size.

3. A method to compute blockchain state function value to select an administrator using a formula defined as a unique and surjective mapping between the blockchain state and active registered network nodes based on a blockchain state with N blocks and the transaction batch number computed by the method of claim 2.

4. A method to identify all the failed administrators for a block when an administrator is selected by the method of claim 3 with a transaction batch number greater than 1, using the method of claim 3 to identify all the failed administrators with all the transaction batch numbers that are greater or equal to 1 and less than the administrator's transaction batch number.

5. A process of the state function driven consensus protocol in which each of active registered network nodes follows to receive and process transaction entries, and to build blocks for the blockchain and to synchronize blocks across the decentralized peer-to-peer network, comprising the following steps:
a. each active registered network node has a service end point to listen and receive transaction entries, the transaction entries can be either posted directly from network users, or broadcasted from other active registered network nodes;
b. after a transaction entry is received, validate the transaction; reject the transaction if it is invalid; add the transaction to the TransactionPool entity if it is valid;
c. if the transaction is posted directly from a network user, broadcast the transaction to all live network nodes;
d. compute the state function value of claim 3 to find the selected administrator for building the next block;
e. if the calculated state function value indicates the selected administrator is the active registered network node itself, build the next block.

6. A process for building a block in step e of claim 5 comprising the following steps:
a. move S number of transaction entries from TransactionPool entity to TransactionData entity, where the number S is the transaction pool size when the state function is calculated to select the administrator from step d of claim 5, the transaction entries are marked with a new block id equal to the block id of the last block in the blockchain plus 1, the transaction entries are ordered by the local timestamp when they are received, and each of the transaction entries is assigned a block index ranging from number 1 to S;
b. if there are newly joined network nodes in NetworkNodePool entity, move all the entries from the NetworkNodePool entity to NetworkNode entity, each new network node is marked with the new block id from step a, and the new network nodes are ordered by the local timestamp when they are joined, and each of the new network nodes is assigned a block index ranging from number 1 to L where L is the NetworkNodePool size;
c. use the method of claim 4 to get all failed administrators and create an entry for each of the failed administrators in the NetworkNode entity with the block id from step a, to identify a network node, and to set active flag to N (not active);
d. take all the entries from FunctionParameter entity with previous block id, adjust the parameters if necessary, create entries with block id from step a;
e. compute block hash and add the hash to the block header record with the previous block hash;
f. use the associate wallet's private key to sign the block hash and add the signature to the block header record as the block building certification;
g. append the block the local copy of the blockchain;
h. cleanup TranasctionPool and NetworkNodePool to remove records that have been built into the block;
i. broadcast the new block to all live network nodes;
j. create a transaction entry to pay administration fee to the network node that built the previous block, where the administration fee is paid to the public key of the wallet associate with the network node;
k. broadcast the administration fee transaction entry to all live network nodes.

7. A process for receiving a new block, comprising the following steps:
a. validate block id, where the block id must be equal to the block id plus 1 from the last block of the local copy of the blockchain, If the block id is invalid, reject the block;
b. validate the previous hash value of the block is equal to the hash value of the last block of the local copy of the blockchain, if it is invalid, reject the block;
c. compute the block hash using the block data, validate the computed hash is equal to the hash value of the block, if it is invalid, reject the block;
d. compute the blockchain state function of claim 3 to validate that the block creator is the selected administrator determined by the blockchain state function, if it is invalid, reject the block;
e. use the public key of the block creator to validate the block's certificate, if it is invalid, reject the block;
f. validate all the transaction entries in the block, if any of the entries are found invalid, reject the block;
g. if all the validations from the above steps are passed, append the received block to the local copy of the blockchain;
h. cleanup TranasctionPool and NetworkNodePool to remove records that have been built into the block.

8. A process for a network node to join or rejoin the peer-to-peer blockchain network, comprising the following steps:
a. if the node is a new member to join the network at first time, create a network id, create a wallet with public and private key pair for the node;
b. if the node is an existing member being offline or a removed FA to rejoin the network, enter the member wallet private key to validate the existing membership;
c. load and synchronize blockchain data from an active registered network node (seed);
d. create an entry in NetworkNodePool for node;
e. broadcast the joined/rejoined node to all live network nodes.
